(19) United States
(12) Patent Application Publication
(10) Pub. No.: US 2009/0078596 A1
(43) Pub. Date: Mar. 26, 2009

(54) Baby care kit, a method for forming a baby care kit, and a method for selling/marketing baby apparel

(76) Inventor: Megan L. Frump, Lincoln Park, MI (US)

Correspondence Address: John G. Chupa;Law Offices of John Chupa and Associates, P.C., Suite 50, 28535 Orchard Lake Rd., Farmington Hills, MI, 48334, US

(21) Appl. No.: 11/903,628

(22) Filed: Sep. 24, 2007

(51) Int. Cl. B65D 69/00; G06Q 30/00; G06Q 90/00

(52) U.S. Cl. 206/223; 705/1

(57) ABSTRACT

A baby care kit 100 which includes a baby sleeper outfit stuffed with baby care supplies and formed into a stuffed baby thereby creating a baby care kit that is novel and highly aesthetically pleasing. A method for forming a baby care kit, and a business method for selling a baby care kit is also provided.

### GENERAL BACKGROUND

1. Field of the Invention

The present invention generally relates to a baby-care kit, to a method of forming a baby-care kit, and to a method for selling/marketing baby apparel, and more particularly, by way of example and without limitation, to a baby care kit which contains a plurality of baby care items which are dynamically selected according to the respective needs of customers and which is formed in the shape of a baby, thereby creating an aesthetically pleasing baby-care kit that is particularly useful for an expecting mother and which may be easily and selectively marketed and sold.

2. Background of the Invention

Baby care kits or assemblies are widely used and selectively contain baby care supplies, such as and without limitation bottles, diapers, bibs, as well as other items which may be selectively used for the proper care of a baby. Particularly, these baby-care kits, containing different baby-care supplies, provide users with a convenient, easy, and relatively inexpensive way to acquire several different baby-care supplies in the convenience of one package. And because of the ease of obtaining a plurality and variety of baby care supplies in one package, find a ready audience with expectant mothers, parents, babysitters, nurseries, hospitals, and other segments of the population. However, while such baby-care kits do provide a plurality of baby-care items in a convenient package, such kits suffer from drawbacks.

Baby care kits are not formed to address the specific needs of different users, and therefore come packaged with general baby care items, some of which users may already have or otherwise not wish to have included within the baby care kits. Thus these baby care kits do not provide users with choices to create their own individualized baby care kits.

Other baby care kits are packaged with a limited variety of “necessary items”, and which requires that the user supplement these kits with additional purchases which add to the overall cost of purchasing baby care supplies. No one, to the Applicant's knowledge, is allowing these kits to be tailored or programmed or dynamically created to address the needs of particular and specific consumers.

Yet further, other baby care kits are typically packaged in unaesthetically pleasing packages. While these packages do provide security and convenience, they are not preferred to be given as gifts at social occasions (for example, a baby shower) on account of their unaesthetically pleasing packaging. There is therefore a need for a new method and a kit assembly that overcomes these and other disadvantages and drawbacks of prior and currently utilized baby-care kits in a new and novel manner and which is more fully delineated below.

### SUMMARY OF THE INVENTION

It is a first non-limiting object of the present invention to provide a baby-care kit, which overcomes some of the previously delineated drawbacks of prior and existing baby-care kits.

It is a second non-limiting object of the present invention to provide a novel baby-care kit type assembly which may be dynamically created to meet the needs of particular consumers.

It is a third non-limiting object of the present invention to provide a novel method and a novel kit assembly that is formed from a baby sleeper outfit that is overall aesthetically pleasing.

According to a first non-limiting aspect of the present invention, a baby care kit is provided and includes a baby sleeper outfit having an inside cavity; a plurality of baby care items packaged within the inside cavity; and a head portion coupled to the baby sleeper outfit, thereby forming a baby care kit containing a plurality of baby care items.

According to a second non-limiting aspect of the present invention, a baby care kit is provided and includes a baby sleeper outfit comprising a body, a pair of hands, a pair of legs, and an inside cavity; a plurality of baby care items stuffed inside the cavity, thereby filling the inside cavity of said baby sleeper outfit; a head portion coupled to the baby sleeper outfit; a plurality of pins coupled to the head portion, thereby forming a stuffed baby; a bib selectively coupled to the head portion, thereby forming a baby care kit substantially in the form of a baby.

According to a third non-limiting aspect of the present invention, a method of forming a baby care kit is provided comprising the steps of providing a baby sleeper and filling the baby sleeper with a plurality of baby care items; forming a head and attaching the head to the baby sleeper; attaching a hat to the head, thereby forming a stuffed baby; attaching a bib to the stuffed baby; placing the stuffed baby in a basket; placing a bottle and a toy in the basket; and covering the stuffed baby with a blanket and securing the stuffed baby to the basket.

According to a fourth non-limiting aspect of the present invention, a business method is provided and includes the steps of soliciting an order from a buyer for a baby care kit type assembly; receiving the order including a type and a number of baby components required; placing the type and the number of required baby components into a kit which has a form of a baby; receiving money for the kit; and providing the kit to a buyer.

These and other features, aspects, and advantages of the present invention will become apparent to those of ordinary skill in the art from a reading of the following detailed description of the preferred embodiment of the invention, including the subjoined claims, and by reference to the following drawings.

### BRIEF DESCRIPTION OF THE DRAWINGS

FIG. 1 is a perspective view of a baby care kit type assembly that is made in accordance with the teachings of the preferred embodiment of the invention.

FIG. 2 is an unassembled view of a baby care kit type assembly which is shown in FIG. 1, that is made in accordance with the teachings of the several embodiments of the invention.

FIG. 3 is a flow chart illustrating the method of forming a baby care type kit assembly according to the teachings of the preferred embodiment of the invention.

FIG. 4 is a flow chart illustrating the business method of the invention.

### DETAILED DESCRIPTION OF THE PREFERRED EMBODIMENT OF THE INVENTION

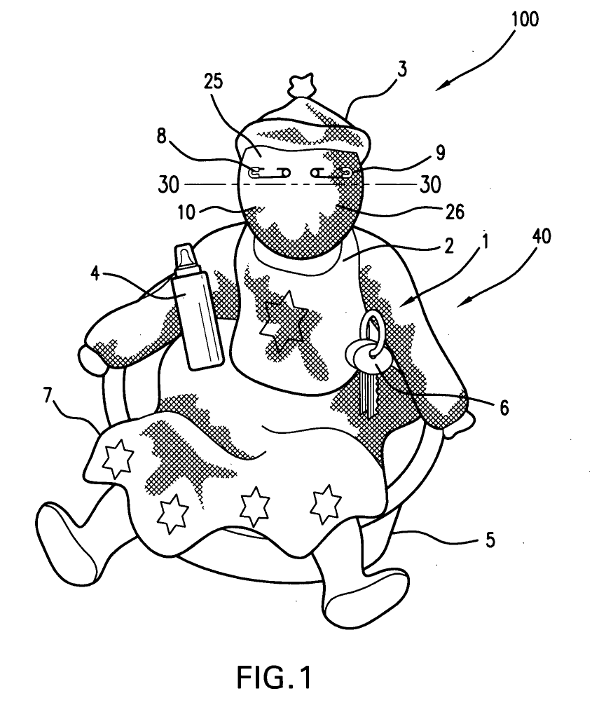

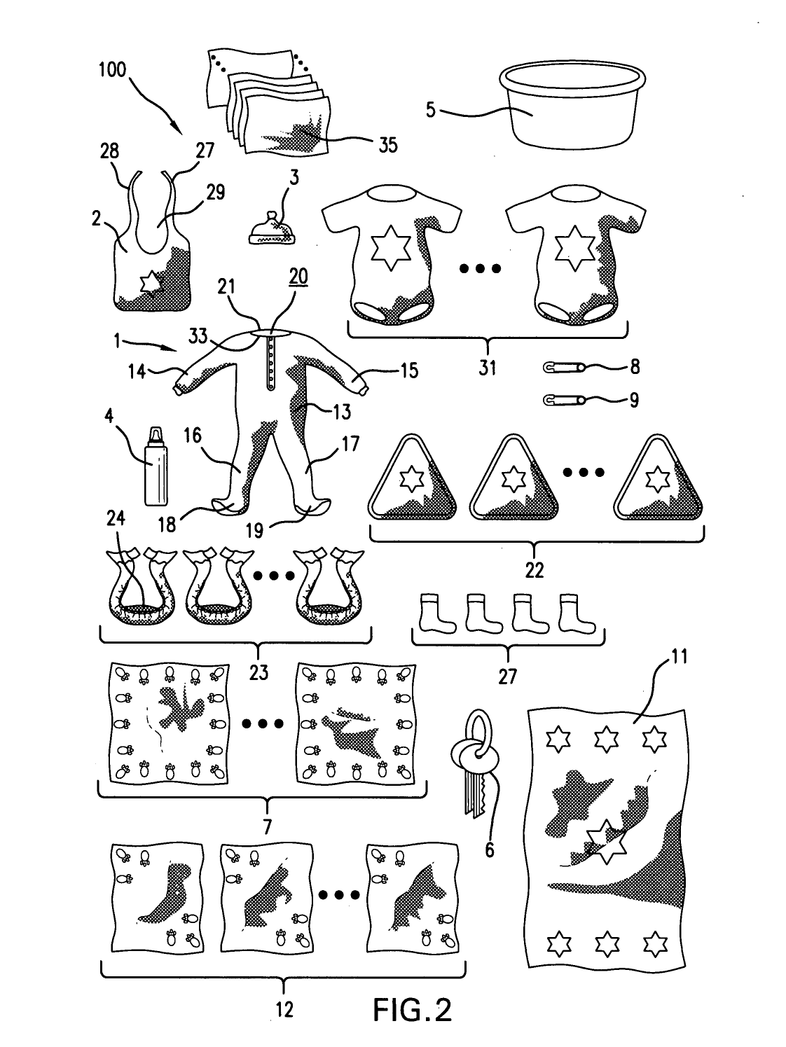

Referring now to FIGS. 1 and 2, there is shown a baby care kit type assembly 100 which is made in accordance with the teachings of the first non-limiting and preferred embodiment of the invention. It should be appreciated that the terms “baby care kit type assembly” and “baby care kit” may be interchangeably utilized throughout this description and each of which describe a dynamically creatable assembly of baby items which may be selectively formed in an aesthetically pleasing shape. It should further be appreciated that like reference numbers used on different figures represent the same features.

Particularly, the baby care kit assembly 100 includes, in the preferred embodiment, a selectively removable baby sleeper outfit 1. It should be appreciated that “outfit” 1 may be replaced by or represented by any piece of baby clothing having an interior cavity and a pair of legs and arms. Particularly, baby sleeper outfit 1 is, in one embodiment, a one-piece infant outfit and comprises a body portion 13, a neck portion 21 attached to body portion 13, a plurality of arm portions 14,15 attached to body portion 13, and a plurality of leg portions 16, 17 for generally receiving a baby's legs. The baby sleeper outfit 1 further comprises foot portions 18, 19 which integrally attach and terminate at leg portions 16, 17 respectively (i.e. leg portion 16 terminates into foot portion 18, and leg portion 17 terminates into foot portion 19), although in other non-limiting embodiments, a baby sleeper outfit 1 which does not include foot portions 18, 19 may be utilized. One non-limiting example of such an outfit 1 is that commonly referred to as “blanket sleeper” and commercially available from the Gerber® Corporation and is shown on website www.gerberchildrenswear.com. Moreover, arm portions 14, 15, leg portions 16, 17, and body portion 13 cooperate to form a baby sleeper outfit 1 having an inside space or cavity 20, and which is typically used for receiving a baby. It should be appreciated that any commercially available baby sleeper outfit having the desired features and characteristics may be used and that nothing in this description limits the baby sleeper outfit 1 to a particular type of commercially available outfit.

The baby care kit 100 further, in one non-limiting embodiment, comprises a plurality of “Onesies” or bodysuit 31, a bath towel 11, a plurality of wash cloths 12, a plurality of burp cloths or burp pads 22, a plurality of diapers 23, a plurality of socks 27, and a plurality of baby blankets 7, respectively and removably residing within the hollow cavity 20. That is baby sleeper 1 is filled or “stuffed” with baby care items so as to occupy the cavity 20 within sleeper outfit 1. In other non-limiting embodiments, tissue paper 35 may additionally be utilized to fill cavity 20. The items 7, 31, 11, 12, 22, 23, 27 cooperatively and in other non-limiting embodiments, any other combination, number or type of baby care items may form “baby care supplies” and may be selectively provided within baby sleeper 1 based on needs and preferences of users. Non-limiting examples of such items 7, 31, 11, 12, 22, 23, 27 are as follows:

| | |
|---|---|
| Onesies 31 | Onesies ® by Gerber as shown on website |
| | www.gerberchildrenswear.com |
| Baby blanket 7 | Receiving blankets by Luvable Friends ® as |
| | shown on website www.luvablefriends.com |
| Bath towel 11 | Baby Bath Towel by Luvable Friends ® as |
| | shown on website www.luvablefriends.com |
| Wash cloth 12 | Johnson's ® Baby Bedtime Washcloths as |
| | shown on website www.drugstore.com |
| Burp cloth 22 | Terry Burp Cloth by Gerber ® as shown on |
| | website www.gerberchildrenswear.com |
| Socks 27 | Terry Baby Socks by Luvable Friends ® as |
| | shown on website www.luvablefriends.com |
| Diaper 23 | Disposable diapers by HUGGIES ® as shown on |
| | website www.happyhealthypregnancy.com |

In other non-limiting examples, the baby sleeper outfit 1 may be “stuffed” with a plurality of newborn diapers 23, such as in one non-limiting example disposable diapers made by HUGGIES®, a plurality of burp cloths 22, and/or tissue paper 35. Still further, in other non-limiting embodiments, the baby sleeper outfit 1 is stuffed only with a plurality of burp cloths 22 and plurality of tissue paper 35. The baby sleeper outfit 1 is of a desired size and shape to fit the “targeted” baby which is specified by the customer ordering the kit 100.

The kit type assembly 100 further includes a head portion 10, which is selectively and removably attached to sleeper 1 at neck portion 21 and occupies the circular space 33 in neck portion 21. That is, head portion 10 comprises a newborn disposable diaper 23 which contains a plurality of the aforementioned baby care items residing within inside pocket 24 and which is rolled or formed into a substantially spherical shape while the plurality of other diapers 23, in one non-limiting embodiment, is stuffed into baby sleeper outfit 1. The head portion 10 is further selectively and fixedly attached to baby sleeper 1 at open end 21 of baby sleeper outfit 1 and this attachment could be made by any method such as but not limited to pins or tape.

In other non-limiting embodiments, the head portion 10 comprises a burp cloth 22 rolled or formed into a substantially spherical shape as diaper 23 of the preferred embodiment, and burp cloth 22 encloses a plurality of the previously mentioned baby care items and/or tissue paper, while rest of burp cloths 22 are stuffed within baby sleeper outfit 1.

The baby care kit 100 in the preferred embodiment also comprises a pair of substantially identical safety pins 8, 9 that are selectively and removably attached to head portion 10. That is safety pins 8, 9 are securely attached to head portion 10 along top portion 25 which is formed by horizontal axis of symmetry 30 which divides head portion 10 in two symmetrical top portion 25 and bottom portion 26. Further, pins 8, 9 are attached to and equally spaced apart on top portion 25 to simulate “eyes”. The baby care kit 100 also comprises a hat 3 that is provided and selectively attached to and covers a surface of top portion 25 while exposing pins 8,9. The combination of the stuffed baby sleeper 1, head portion 10, hat 3, and pins 8, 9 collectively form a shape that substantially resembles a “stuffed baby” 40, as best shown in FIG. 1. It should be appreciated that any combination of “baby care items” may be selectively and removably stuffed inside the baby sleeper 1 to form stuffed baby 40 containing baby care items that can be tailored to any user and may be formed in a very efficient and highly aesthetically pleasing package.

Further, baby care kit 100 also includes, in one non-limiting embodiment, a bib 2 which includes tie cords 28, 29 and which is selectively and removably attached to baby sleeper 1. That is, bib 2 is placed on chest 13 of sleeper 1 and tie-cords 28, 29 of bib 2 are wrapped around neck portion 21 and attached to each other (i.e., tie-cord 28 is attached to tie cord 29) to securely attach bib 2 to head portion 10. In order to complete the baby care kit 100 of the preferred embodiment, the “stuffed baby” 40 with the selectively and removably attached bib 2 is placed in a basket 5 so that the “stuffed baby” 40 is arranged in a reclining and seated position as shown in FIG. 1, and a baby bottle 4 and a toy 6 are positioned next to the “stuffed baby” 40 within basket 5.

Baby care kit 100 also, in the preferred embodiment, comprises a baby blanket 7 that is selectively and removably attached to basket 5. That is baby blanket 7 is selectively positioned and covers leg portions 16, 17 so as to cover leg portions 16, 17 while baby blanket 7 is selectively inserted under arm portions 14, 15 (i.e., baby blanket 7 covers leg portions 16, 17 while arms 14, 15 are exposed above baby blanket 7), although any other method may be utilized to attach baby blanket 7 to “stuffed” baby 40 such as, but not limited to pins or tape. It should be appreciated that baby blanket 7 is not limited to any particular size or shape, and any commercially available baby blanket 7 may be selected for baby care kit 100. Thus, a novel baby care kit 100 is provided which contains a plurality of baby care items chosen based on preferences of users and which is formed in the shape of a baby, thereby creating an convenient, user defined and highly aesthetically pleasing baby care kit.

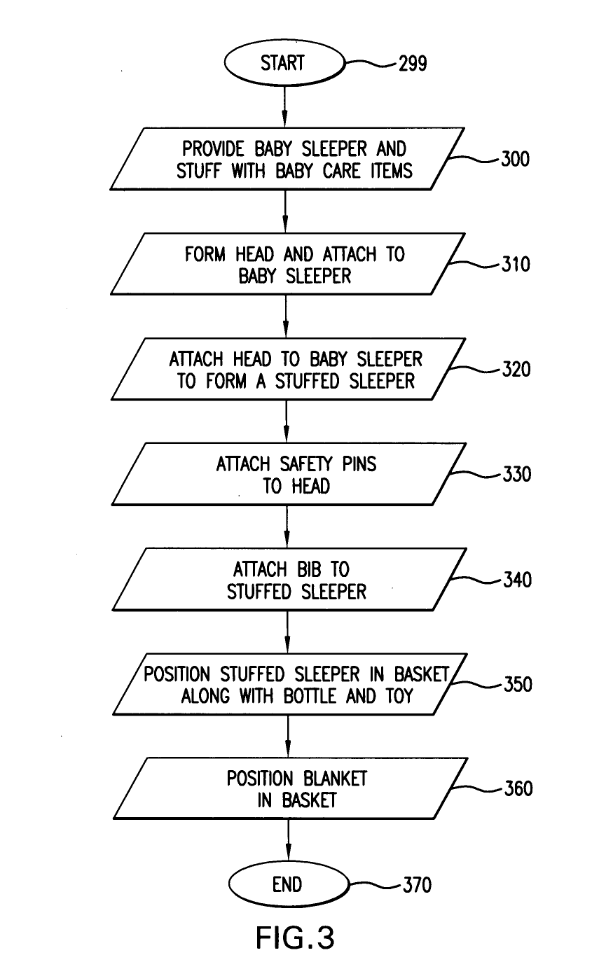

Referring now to FIG. 3, there is shown a methodology or flow chart 299 comprising a method of forming a baby care kit, such as baby care type kit assembly 100.

Specifically, methodology 299 begins with step 300, baby sleeper 1 is provided and stuffed with a plurality of baby care items. Step 300 is followed by step 310 in which head 1 is formed or provided and attached to baby sleeper 1 at sleeper neck portion 21 to form a stuffed sleeper.

Step 320 follows step 310 and, in step 320, hat 3 is attached to head 1. Step 320 is followed by step 330 in which safety pins 8, 9 are attached to head 1 at top portion of head 1. Step 340 follows step 330 and, in step 340, bib 2 is attached to sleeper 1 by tying cords 28, 29 around head 1 to securely attach bib to stuffed sleeper.

Step 340 is followed by step 350, and in step 350, the stuffed sleeper 40 and bib 2 are positioned in basket 5 along with bottle 4 and toy 6. Step 360 follows step 350 and in step 360, blanket 7 is formed around arms 14, 15 and legs 16, 17 of baby sleeper 1 to secure baby sleeper 1 in basket 5. Step 370 follows step 360 and denotes the formation of a baby care kit 100.

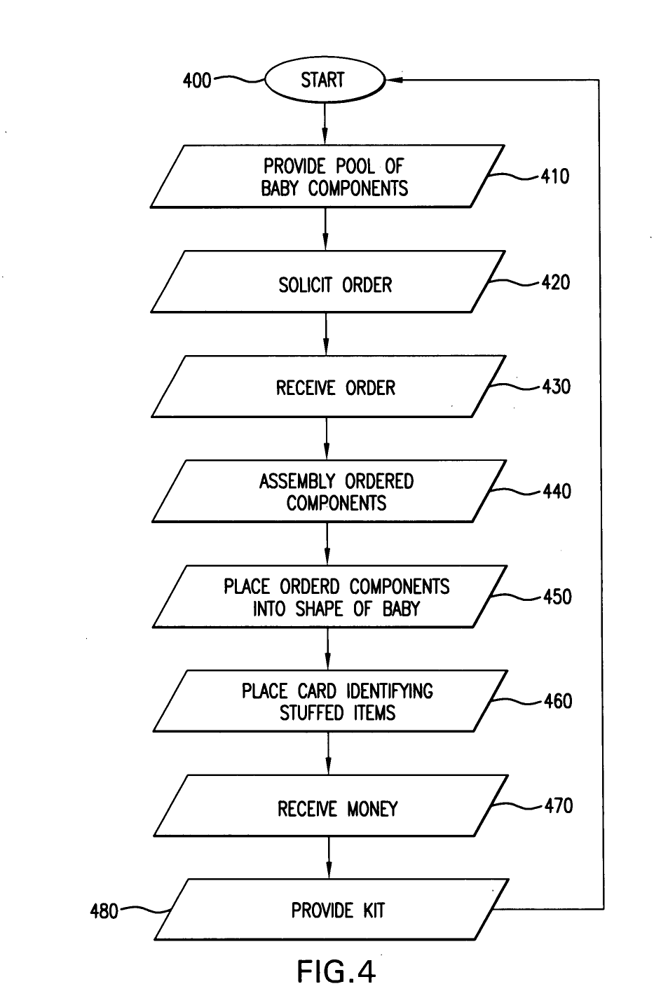

Referring now to FIG. 4, there is shown a methodology or flow chart 400 comprising a business method of selling/marketing a baby care kit type assembly, such as baby care kit type assembly 100.

Specifically, methodology 400 begins with step 410, and in step 410, a pool of baby components if provided. Step 410 is followed by step 420 which comprises soliciting an order for a baby care kit. Step 430 follows step 420 in which an order is received and includes the type and number of baby components required for baby care kit 100. Step 430 is followed by step 440 and in step 440 ordered components are assembled. Step 450 follows step 440 and in this step, ordered components are ordered into a shape of a baby. Step 460 follows step 450 and in step 460 a card is attached identifying stuffed items. Step 470 follows step 460, and in this step, money is received for baby care kit 100. Step 480 follows step 490 in which baby care kit assembly 100 is provided. It should be appreciated that methodology 400 may be repeated as necessary for selling/marketing any additional baby care kit type assembly, such as baby care kit type assembly 100. Once the intended recipient receives the baby kit 100, the recipient may then selectively disassemble the baby care kit type 100 and begin to utilize the items. The selective formation of the baby items into this “baby shape” is a novelty which is designed to have the purchase and use of the items be a “fun experience” and a profitable one for the provider.

Thus, it should be appreciated that the foregoing inventions, in part, provide a baby care kit type assembly 1 and a method of forming a baby-care kit assembly which allows a user to select from a plurality of baby-care items to form a baby-care kit that is convenient, efficient, and a highly aesthetically pleasing method of giving baby care items.

What is claimed is:

1) A baby care kit comprising:
a baby sleeper outfit having an inside cavity;
a plurality of baby care items packaged within said inside cavity; and
a head portion coupled to said baby sleeper outfit, thereby forming a baby care kit containing a plurality of baby care items.

2) A baby care kit in the shape of a baby comprising:
a baby sleeper outfit comprising a body, a pair of hands, a pair of legs, and an inside cavity;
a plurality of baby care items stuffed inside said cavity, thereby filling said inside cavity of said baby sleeper outfit;
a head portion coupled to said baby sleeper outfit;
a plurality of pins coupled to said head portion, thereby forming a stuffed baby;
a bib selectively coupled to said head portion, thereby forming a baby care kit substantially in the form of a baby.

3) The baby care kit of claim 2 further comprising a basket, wherein said stuffed baby removably resides.

4) The baby care kit of claim 3 further comprising a toy disposed within said basket.

5) The baby care kit of claim 4 further comprising a bottle disposed within said basket.

6) The baby care kit of claim 5 further comprising a blanket covering a portion of said stuffed baby.

7) A method of forming a baby care kit type assembly comprising the steps of:
providing a baby sleeper and filling said baby sleeper with a plurality of baby care items;
forming a head and attaching said head to said baby sleeper;
attaching a hat to said head, thereby forming a stuffed baby;
attaching a bib to said stuffed baby;
placing said stuffed baby in a basket;
placing a bottle and a toy in said basket; and
covering said stuffed baby with a blanket and securing said stuffed baby to said basket.

8) A method of selling a baby care kit type assembly comprising the steps of:
soliciting an order from a buyer for a baby care kit type assembly;
receiving said order including a type and a number of baby components required;
placing said type and said number of said baby components into a kit which has a form of a baby;
receiving money for said kit; and
providing said kit to a buyer.
